(19) United States
(12) Patent Application Publication
(10) Pub. No.: US 2002/0125992 A1
(43) Pub. Date: Sep. 12, 2002

(54) Access control assemblies for door locking mechanisms

(76) Inventor: Alan Robert Harwood, Hayes (GB)

Correspondence Address: QUARLES & BRADY LLP, 411 E. WISCONSIN AVENUE, SUITE 2040, MILWAUKEE, WI, 53202-4497, US

(21) Appl. No.: 10/039,732

(22) Filed: Apr. 26, 2002

(30) Foreign Application Priority Data
Oct. 27, 2000 (GB) GB 0026281.6

(51) Int. Cl. G06F 7/04

(52) U.S. Cl. 340/5.51; 340/5.54; 340/5.7; 341/22; 235/382; 70/278.1

(57) ABSTRACT

A door access control assembly (10, 12) is provided for mounting on a door (11) or on a cabinet provided with a door, the control assembly comprising a self-contained access control unit (10), and a circuit board housing (12) adapted to be mounted on a planar surface of the door or cabinet wall. A printed circuit board (PCB) is mounted within the circuit board housing (12), and circuitry of the printed circuit board is configured to provide an output signal to a door lock release mechanism in response to suitable release signals generated by the access control unit. The self-contained access control unit (10) takes the form of an activation module comprising a module housing, and release signal generating circuitry housed within the module housing. The activation module has an electrical plug and socket connection (14) with the printed circuit board (PCB). The access control unit (10) may be mounted directly on the outer face (33) of the door or cabinet wall, with the circuit boarding housing (12) mounted on the inner face (34) of the door or cabinet wall (FIG. 11). Alternatively, the access control unit (10) may be accommodated in an aperture (10′) provided in the circuit board housing (12), that housing being mounted on the outer face (33) of the door or cabinet.

A range of interchangeable modules (10) is provided which have different actuating arrangements, such as key-pad, and proximity sensor.

This invention relates to electronic access control assemblies for controlling door locking mechanism, particularly, but not exclusively, locking mechanism for the doors of cabinets adapted to house racking for electrical/electronic equipment, electrical cabling and associated equipment. Such cabinets are often termed ‘racks’.

There is a need to control access by individuals to the electrical/ electronic equipment housed within a cabinet, particularly when the cabinet is located on the premises of a company that does not have responsibility for the working of the equipment within the cabinet.

There are often several cabinets in close proximity, and different people may be authorised to work on different equipment within the various cabinets. For this there can be a requirement to provide an access control system to enable different people to open different doors of the cabinets.

Different companies tend to have different requirements or preferences as to how access to the cabinet doors is to be controlled. For example, one company may favour keypad control of the door locking mechanism, whereas another company may favour a control assembly utilising a proximity sensor, and others may favour the use of a card reader type of access control assembly. Often such access control assemblies are networked and therefore need to be compatible with other control units on the network.

We consider that there is a need for an access control assembly in which the lock activation device is a module which can be selected from a range of available activator modules each of which can interface with circuitry provided on a circuit board housed within the access control assembly.

According to one aspect of the invention we provide a door access control assembly adapted to be mounted on a door or on a cabinet provided with a door, the control assembly comprising a circuit board housing adapted to be mounted on a planar surface of the door or cabinet wall, a printed circuit board mounted within the circuit board housing, the circuitry of the printed circuit board being configured to provide an output signal to a lock release mechanism in response to suitable release signals generated by an access control unit, the access control unit taking the form of an independent activation module comprising a module housing, and release signal generating circuitry housed within the module housing, the activation module having an electrical plug and socket connection with said printed circuit board.

Preferably the plug and socket extend in a direction normal to the printed circuit board whereby on installation the module is electrically connected to the PCB by displacing the module relatively towards the plane of the PCB.

In one embodiment the PCB housing is adapted to be mounted on an external face of the door or cabinet, and the PCB housing contains an aperture in the outwardly-facing face of the PCB housing of complementary shape to that of the said modules to enable any selected one of the modules to be set into the outer face of the PCB housing.

Preferably the outer face of the module is substantially flush with the outwardly-facing face of the PCB housing.

Alternatively the PCB housing may be adapted to be mounted on the inner face of a door or cabinet wall, and the module is adapted to be mounted on the opposite, outer face of the door or cabinet wall.

A power source for the access control assembly may be provided by a battery housed within the PCB housing, or power may be supplied to the assembly by cable from a mains source.

The door locking mechanism is preferably spring-biased to a locked condition and is arranged to be releasable on the application of an appropriate electrical release signal. A suitable door locking mechanism is described in our co-pending patent application No. GB 0026282.4 filed on Oct. 27, 2001 and entitled ‘Lock Assembly and a Method for Operating a Lock Mechanism’.

Some embodiments of the invention will now be described, by way of example only, with reference to the accompanying drawings in which:

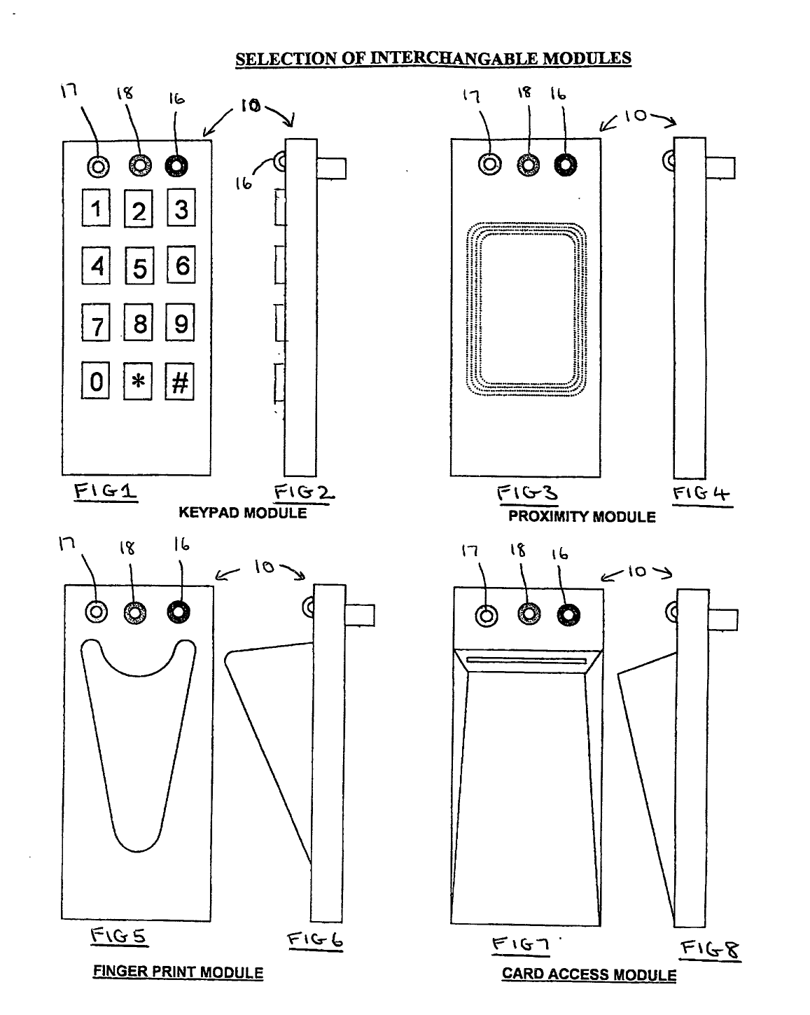

FIGS. 1 and 2 are respectively a front elevation and side elevation of a first activation module in accordance with the invention and in the form of a keypad module;

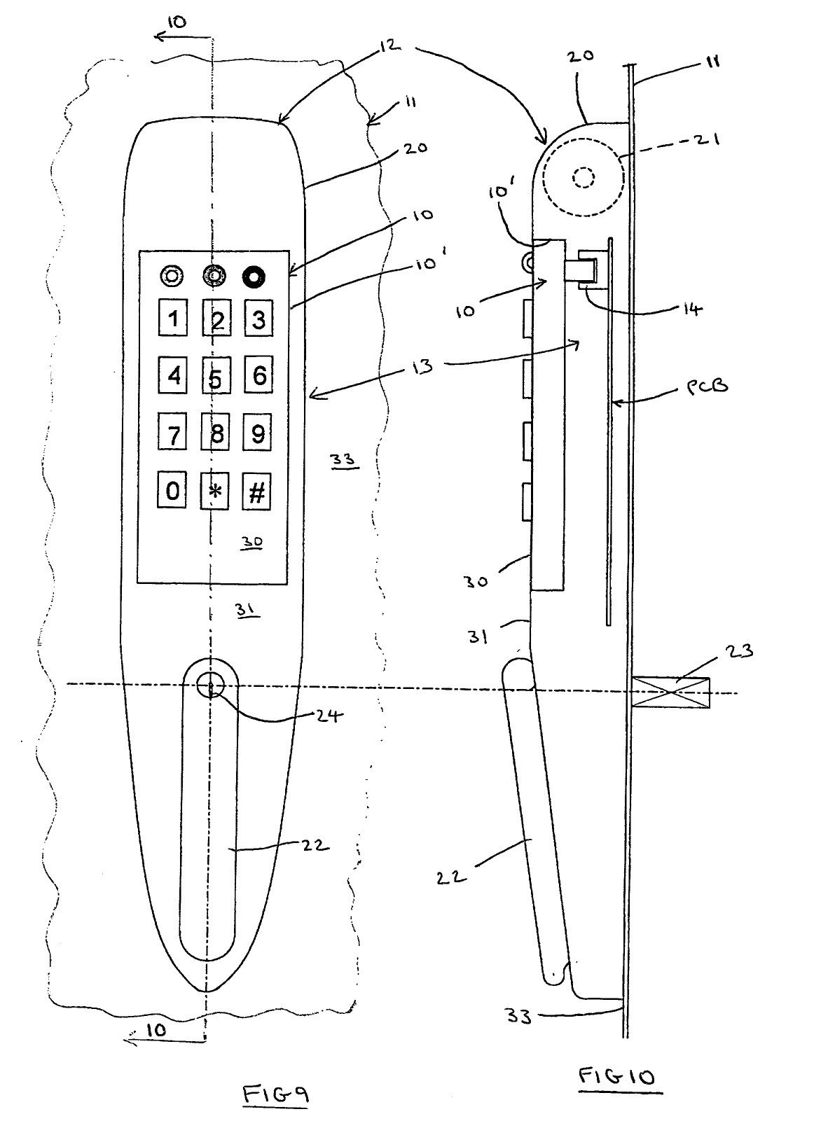

FIGS. 3 and 4 are respectively front and side elevations of a second activation module in accordance with the invention and in the form of a proximity module;

FIGS. 5 and 6 are respectively front and side elevations of a third activation module in accordance with the invention and in the form of a finger print scanning module;

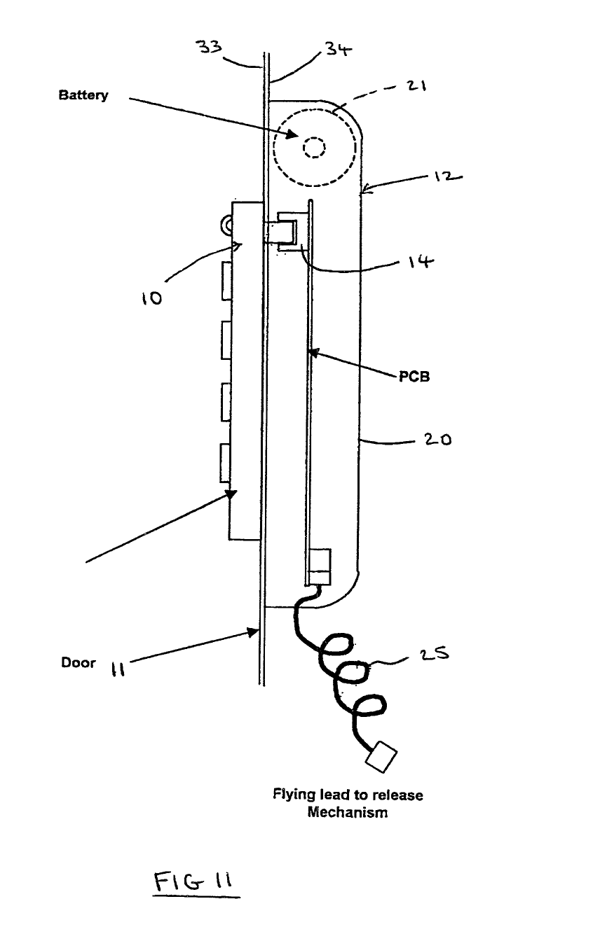

FIGS. 7 and 8 are respectively front and side elevations of a fourth activation module in accordance with the invention and in the form of a card reader module;

FIG. 9 is a front elevation of an access control assembly in accordance with the invention shown fitted with the activation module of FIG. 1 and mounted on a cabinet door.

FIG. 10 is a schematic vertical cross-section on the line 10—10 of FIG. 9; and

FIG. 11 is a view similar to FIG. 10 showing a modified circuit board housing mounted on the rear of a cabinet door, and the activation module of FIG. 1 mounted on the front of the door.

An electronic access control system for controlling locking/release of the door of a cabinet for electronic/electrical equipment has the following five sections:

1) The lock activation device. Keypad, swipe card, IR, proximity, transponder, Dallas key and Biometric devices (Biometric devices are expensive and may need additional processing capability). Some of these types can be combined i.e. proximity & keypad. Each activation device should have a pre-set master override for system administration.

2) Electronic Control Card (PCB). The control card will contain the brain of the system and will control the functionality of each locking system i.e. audit trail, number of access codes, programmability and network capability etc.

3) Power supply. In the case of a networked and zoned entry system, this will require power from the mains supply with the option of battery back-up. Alternatively, a stand alone system would be powered from a suitable battery. (Lithium thionyl chloride cell or an Alkaline cell).

4) Door Latching. This could be a single slam, double slam, bolts, locking rods with a pin and hook, four point locking etc. or any combination of these.

5) Release Mechanism for the lock. The electronic release needs to be designed into the latch so that desirably one design of release can be used with whatever type of latch is used. The release for the lock will need only be left on for a 5 sec period to unlock then be sprung back to lock the system, this will save battery power on the stand alone system. The networking and zoned entry system will need a timed period from may be 1 to 2000 seconds for the lock to be opened.

Description of the Activation Module. (FIGS. 1 to 8 Illustrate Four Module Options)

The activation module 10 can be mounted either directly to the door 11 as in FIG. 11, or into the main unit 12 of a battery powered self contained assembly 13 as in FIGS. 9, 10 and carries a rearwardly projecting plug 15 to plug directly into a socket 14 on the PCB. Input signals from the module will be passed to the PCB and be processed either to allow access or deny it and record the event. The three LED's 16, 17, 18, one red, one amber the other green will indicate various conditions during this process. When the amber light 17 is on it indicates that the system is live and ready to receive an input. A flashing amber light 17 would mean the system is live and ready to receive an input but the battery needs replacement for the battery-powered system. If no input is received in five seconds the red light 16 will light indicating the release mechanism is still locked (no input will be accepted while the red light is on). If the correct code is received while the amber light 17 is on the amber light will switch off and the green light 18 will switch on indicating the release mechanism has been activated allowing the door 11 to be opened. After five seconds the release will deactivate allowing the door to be locked, the green light will switch off and the red light switch on for five seconds.

The Self-contained Assembly 13

In FIGS. 9 and 10 the main unit 13, which fits on the outer face 33 of the door 11 is secured to the door from the inside of the door with screws, not shown. The main unit 13 comprises a PCB housing 20 which houses all the components, PCB, battery 21, lock release mechanism and locking handle 22, and receives the interchangeable activation module 10 in a rectangular aperture 10′ of corresponding dimensions to that of the housing of module 10, such that the outer face 30 of the module 10 is substantially flush with the outwardly-facing face 31 of the housing 20.

The activation module 10 is retained by a screw, not shown, accessible from inside the main unit 13. The battery 21 is desirably in a compartment, which allows the battery to be changed from the outside, and the system is arranged to retain all its settings while the battery is being changed.

The release mechanism, not shown, is desirably also within the housing 20 and is designed to lock rotation of the square drive shaft 23, a shear pin 24 between the shaft 23 and swing handle 22 will protect the lock being forced.

Advantages of the assembly of FIGS. 9 and 10 are ease of installation, without additional wiring the ability to operate a number of different types of latching systems on doors by way of the drive shaft 23. No mains power is required to power the lock, if the system fails it fails secure, and replacement of the assembly is simple.

Battery life is critical to this design, so when not in use the system is arranged to sleep and only wake up when activated. The awake period is limited to save power, and the time to enter the code and the release period is desirably kept to a minimum.

FIG. 11 illustrates the same battery system in a different configuration. In this configuration the interchangeable activation unit 10 is fitted to the outside face 33 of the door 11 or cabinet wall, and the battery 21 and PCB in PCB housing 20 mounted on the inside face 34. A flying lead 25 from the PCB powers the release which may be sited away from the control assembly.

Description of a Network System

Systems that require Networking or zoned entry will require mains power and a control box will be needed to house the power supply and battery back-up, this box may be sized to fit into a recess in the top end frame of a cabinet assembly. The cabling should be kept to a minimum and should be modular for ease of assembly. The zoned entry system should desirably be capable of expanding into a fully networked solution. A zoned entry system may offer the lowest cost per rack solution. The assembly described previously and illustrated in FIG. 11 can be adapted into a zoned or network solution with the addition of a separate power supply and backup battery unit. The following features are desirable

Fail-safe/Fail-secure option.

Fixed time release period for lock of 5 seconds.

Master Code override of access control system.

Visible indication of correct code entry and release activation period.

Visible indication of system awake, green LED also this LED to flash to indicate battery low.

Minimum code combinations of 10000 for keypad 1000000 for other devices.

Battery powered minimum number of cycles 5000 before battery replacement or once a year.

Slam action door.

Two point locking door.

Minimum numbers of users 50 with individual access codes.

Visible indication of an unlatched door i.e. when the release is locked and the door is open.

Forced door alarm Piezoelectric type or may be the same as above.

Event recorder, last 200 events minimum.

Output of last events to PC or printer. (Audit trail).

Networking and Zoned Entry Options

The following features are desirable

All the options above.

Variable timed release period of between 1 and 2000 seconds.

Mains powered.

Mains powered plus battery backup.

Control card accepts input from all activation devices.

Networking link to PC for control and alarm.

Tamper alarm for forced activation device, control box and cables.

Zoned entry, 20 plus zones each zone 2 to 40 doors.

We claim:

1. A door access control assembly for mounting on a door or on a cabinet provided with a door, the control assembly comprising an access control unit, a circuit board housing adapted to be mounted on a planar surface of the door or cabinet wall, a printed circuit board mounted within said circuit board housing, circuitry of said printed circuit board being configured to provide an output signal to a lock release mechanism in response to suitable release signals generated by said access control unit, said access control unit taking the form of an independent activation module comprising a module housing, and release signal generating circuitry housed within said module housing, said activation module having an electrical plug and socket connection with said printed circuit board.

2. A control assembly as claimed in claim 1 wherein said plug and socket extend in a direction normal to said printed circuit board whereby on installation said module is electrically connected to the printed circuit board by displacing said module relatively towards the plane of said printed circuit board.

3. A control assembly as claimed in claim 1 wherein said circuit board housing is adapted to be mounted on an external face of said door or cabinet, and said circuit board housing comprises an outwardly-facing face which contains an aperture of complementary shape to that of a range of interchangeable modules to enable any selected one of said range of modules to be set into the outer face of the circuit board housing.

4. A control assembly as in claim 3 wherein the outer face of the module is substantially flush with the outwardly-facing face of the circuit board housing.

5. A control assembly as claimed in claim 1 wherein said circuit board housing is adapted to be mounted on the inner face of a door or cabinet wall, and said module is adapted to be mounted on the opposite, outer face of the door or cabinet wall.

6. A control assembly as claimed in claim 1 comprising a battery housed within said circuit board housing.

7. A control assembly as claimed in claim 1 for controlling a door locking mechanism that is spring-biased to a locked condition and is arranged to be releasable on the application of an appropriate electrical release signal by said control assembly.
